(19) United States
(12) Patent Application Publication
(10) Pub. No.: US 2008/0278072 A1
(43) Pub. Date: Nov. 13, 2008

(54) Organic light emitting device and method of producing the same

(75) Inventors: Jeoung-Kwen NOH, Daejeon Metropolitan City (KR); Min-Soo KANG, Daejeon Metropolitan City (KR); Jong-Seok KIM, Seoul (KR); Kong-Kyeom KIM, Daejeon Metropolitan City (KR)

Correspondence Address: MCKENNA LONG & ALDRIDGE LLP, 1900 K STREET, NW, WASHINGTON, DC, 20006, US

(73) Assignee: LG CHEM, LTD., Seoul (KR)

(21) Appl. No.: 12/149,275

(22) Filed: Apr. 29, 2008

(30) Foreign Application Priority Data
Apr. 30, 2007 (KR) 2007-0042085

(51) Int. Cl. H01J 1/62

(52) U.S. Cl. 313/504

(57) ABSTRACT

The present invention provides an organic light emitting device that includes a first electrode, a second electrode, and at least one organic material layer that includes a light emitting layer disposed between the electrodes, and a method of producing the same wherein at least one layer of the organic material layer includes an electron transporting material and at least one selected from the group consisting of metal halides, metal oxides and organic metal and electron transporting material is the compound having the functional group selected from the group consisting of an imidazole group, an oxazole group, a thiazole group, a quinoline group and a phenanthroline group.

### TECHNICAL FIELD

The present invention relates to an organic light emitting device and a method of producing the same. More particularly, the present invention relates to an organic light emitting device that does not affect electron injecting and transporting properties, has excellent organic light emitting device properties, and is produced by using a simple process, and a method of producing the same. This application claims priority from Korea Patent Application No. 10-2007-0042085 filed on Apr. 30, 2007 in the KIPO, the disclosure of which is incorporated herein by reference in its entirety.

### BACKGROUND ART

Generally, the term “organic light emitting phenomenon” refers to a phenomenon in which electric energy is converted to light energy by using an organic material. An organic light emitting device using the organic light emitting phenomenon typically includes an anode, a cathode, and an organic material layer that is interposed between the anode and the cathode. The organic material layer is to have a multilayered structure made of different material in order to improve efficiency and stability of the organic light emitting device. For example, the organic material layer may be formed of a hole injection layer, a hole transporting layer, a light emitting layer, an electron transporting layer, an electron injection layer, and the like. If voltage is applied between two electrodes in the organic light emitting device having the above-mentioned structure, a hole is injected into the organic material layer at an anode and an electron is injected into the organic material layer at a cathode. When the hole meets the electron, an exciton is generated, and light is generated when the exciton is converted into a bottom state. It is known that the organic light emitting device has properties such as self-light emission, high luminance, high efficiency, a low driving voltage, a wide viewing angle, high contrast, and a high-speed response.

The materials used for the organic material layer of the organic light emitting device may be classified into a light emitting material and a charge transporting material, for example, a hole injecting material, a hole transporting material, an electron transporting material, and an electron injecting material according to the type of function.

In order to allow the organic light emitting device to fully exhibit the above-mentioned excellent characteristics, a material constituting the organic material layer in the device, for example, a hole injecting material, a hole transporting material, a light emitting material, an electron transporting material, and an electron injecting material should be essentially composed of a stable and efficient material. However, the development of a stable and efficient organic material layer material for the organic light emitting device has not yet been fully realized. Accordingly, the development of new materials is continuously desired.

### DISCLOSURE

### Technical Problem

The present inventors have found that in an organic light emitting device, when an electron injecting layer is not separately formed and a predetermined material is doped on an electron transporting material in the course of forming the electron transporting layer, performance of the device is improved while electron injecting and transporting characteristics of the device are not changed, and the production process of the device is simplified because the desired performance is obtained even if the electron injecting layer is not separately formed. Therefore, it is an object of the present invention to provide an organic light emitting device that does not affect electron injecting and transporting properties, has excellent performance, and is produced by using a simple process, and a method of producing the same.

### Technical Solution

In order to accomplish the above object, the present invention provides an organic light emitting device that includes a first electrode, a second electrode, and at least one organic material layer that includes a light emitting layer disposed between the electrodes. At least one layer of the organic material layer includes an electron transporting material and at least one selected from the group consisting of metal halides, metal oxides and organic metal. The electron transporting material is the compound having the functional group selected from the group consisting of an imidazole group, an oxazole group, a thiazole group, a quinoline group and a phenanthroline group.

In addition, the present invention provides a method of producing an organic light emitting device, which includes forming a first electrode, forming at least one organic material layer including a light emitting layer on the first electrode, and forming a second electrode on the organic material layer. At least one layer of the organic material layer is formed by doping at least one selected from the group consisting of metal halides, metal oxides and organic metal on an electron transporting material that is the compound having the functional group selected from the group consisting of an imidazole group, an oxazole group, a thiazole group, a quinoline group and a phenanthroline group.

### ADVANTAGEOUS EFFECTS

An organic light emitting device according to the present invention includes an organic material layer on which at least one selected from the group consisting of metal halides, metal oxides, and organic metal is doped on an electron transporting material that is the compound having the functional group selected from the group consisting of an imidazole group, an oxazole group, a thiazole group, a quinoline group and a phenanthroline group. Accordingly, even if a separate electron injecting layer is not used, the electron injecting and transporting characteristics are excellent, thus, a production process is simple and economic efficiency is assured as compared to a known technology.

### DESCRIPTION OF DRAWINGS

FIG. 1 illustrates a current density according to DC bias voltage of an organic light emitting device of Example 1;

FIG. 2 illustrates a current efficiency according to the current density of the organic light emitting device of Example 1;

FIG. 3 illustrates a current density according to bias voltage of an organic light emitting device of Example 1; and

FIG. 4 illustrates a current density according to bias voltage in respects to each of four organic light emitting devices that are produced in Example 2.

### BEST MODE

Hereinafter, the present invention will be described in detail.

In an organic light emitting device according to the present invention, among organic material layers that are disposed between two electrodes, at least on organic material layer comprises an electron transporting material and at least one selected from the group consisting of metal halides, metal oxides and organic metal. The electron transporting material is the compound having the functional group selected from the group consisting of an imidazole group, an oxazole group, a thiazole group, a quinoline group and a phenanthroline group. In the present invention, in the course of forming a layer used to transport the electrons among the organic material layers, in the case of when metal halides, metal oxides, inorganic metal, or organic metal is doped on the above electron transporting material, the organic light emitting device characteristic is significantly improved while electron injecting and transporting characteristics are not affected. Therefore, even if the formation of the electron injecting layer, which is considered to be necessarily performed in order to efficiently operate the organic light emitting device in the related art, is not performed, the organic light emitting device is efficiently operated. In addition, the doping of the above-mentioned doping material on the above electron transporting material positively affects a life span of the device. Methods of doping known metal having a low work function on the electron transporting material to increase efficiency of the organic light emitting device without the electron injecting layer are known. However, the methods are known to be problematic in that it is difficult to use oxidizable metals having the low work function in practice due to a process difficulty and explosiveness.

In the present invention, the above electron transporting material is a material that can transmit the electrons injected from the cathode to the light emitting layer and has the high movability in respects to the electrons.

In the present invention, preferred examples of the compound having the functional group that is selected from the group consisting of the imidazole group, the oxazole group, and the thiazole group include a compound that is represented by the following Formula 1 or 2.

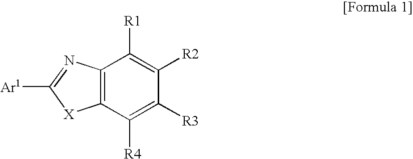

In the above Formula 1, R¹ to R⁴ may be the same or different from each other, are each independently a hydrogen atom; a C₁ to C₃₀ alkyl group that is unsubstituted or substituted with one or more groups selected from the group consisting of a halogen atom, an amino group, a nitrile group, a nitro group, a C₁ to C₃₀ alkyl group, a C₂ to C₃₀ alkenyl group, a C₁ to C₃₀ alkoxy group, a C₃ to C₃₀ cycloalkyl group, a C₃ to C₃₀ heterocycloalkyl group, a C₅ to C₃₀ aryl group, and a C₂ to C₃₀ heteroaryl group; a C₃ to C₃₀ cycloalkyl group that is unsubstituted or substituted with one or more groups selected from the group consisting of a halogen atom, an amino group, a nitrile group, a nitro group, a C₁ to C₃₀ alkyl group, a C₂ to C₃₀ alkenyl group, a C₁ to C₃₀ alkoxy group, a C₃ to C₃₀ cycloalkyl group, a C₃ to C₃₀ heterocycloalkyl group, a C₅ to C₃₀ aryl group, and a C₂ to C₃₀ heteroaryl group; a C₅ to C₃₀ aryl group that is unsubstituted or substituted with one or more groups selected from the group consisting of a halogen atom, an amino group, a nitrile group, a nitro group, a C₁ to C₃₀ alkyl group, a C₂ to C₃₀ alkenyl group, a C₁ to C₃₀ alkoxy group, a C₃ to C₃₀ cycloalkyl group, a C₃ to C₃₀ heterocycloalkyl group, a C₅ to C₃₀ aryl group, and a C₂ to C₃₀ heteroaryl group; or a C₂ to C₃₀ heteroaryl group that is unsubstituted or substituted with one or more groups selected from the group consisting of a halogen atom, an amino group, a nitrile group, a nitro group, a C₁ to C₃₀ alkyl group, a C₂ to C₃₀ alkenyl group, a C₁ to C₃₀ alkoxy group, a C₃ to C₃₀ cycloalkyl group, a C₃ to C₃₀ heterocycloalkyl group, a C₅ to C₃₀ aryl group, and a C₂ to C₃₀ heteroaryl group, and may form an aliphatic, aromatic, aliphatic hetero, or aromatic hetero condensation ring or a spiro bond in conjunction with a neighboring group; Ar¹ is a hydrogen atom, a substituted or unsubstituted aromatic ring or a substituted or unsubstituted aromatic hetero ring; X is O, S, or NR^{a}, and R^{a} is hydrogen, a C₁ to C₇ aliphatic hydrocarbon, an aromatic ring or an aromatic hetero ring.

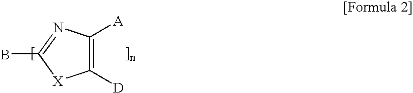

In the above Formula 2, X is O, S, NR^{b} or a C₁ to C₇ divalent hydrocarbon group; A, D, and R^{b} are each a hydrogen atom, a nitrile group (—CN), a nitro group (—NO₂), a C₁ to C₂₄ alkyl, a C₅ to C₂₀ aromatic ring or a hetero-atom substituted aromatic ring, a halogen, or an alkylene or an alkylene containing a hetero-atom that can form a fused ring in conjunction with an adjacent ring; A and D may be connected to each other to form an aromatic or hetero aromatic ring; B is a linkage unit and substituted or unsubstituted alkylene or arylene that conjugately or unconjugately connects multiple hetero rings when n is 2 or more, and substituted or unsubstituted alkyl or aryl when n is 1; and n is an integer in the range of 1 to 8.

Examples of the compound that is represented by the above Formula 1 and used as the compound applied to the above organic substance layer include a compound that is disclosed in Korean Patent Application Publication No. 2003-0067773, and examples of the compound that is represented by the above Formula 2 include a compound that is disclosed in U.S. Pat. No. 5,645,948 and a compound that is disclosed in WO05/097756. The disclosures of above-mentioned documents are incorporated herein by reference in its entirety.

Specifically, the compound that is represented by the above Formula 1 includes the compound that is represented by the following Formula 3.

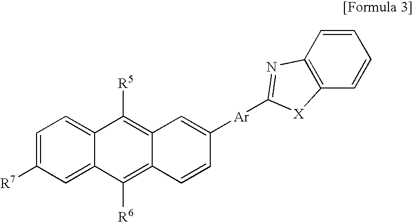

In the above Formula 3, R⁵ to R⁷ are the same or different from each other, are each independently a hydrogen atom, a C₁ to C₂₀ aliphatic hydrocarbon, an aromatic ring, an aromatic hetero ring or an aliphatic or aromatic fused ring; Ar is a direct bond, an aromatic ring or an aromatic hetero ring; and X is O, S, or NR^{a}, R^{a} is a hydrogen atom, a C₁ to C₇ aliphatic hydrocarbon, an aromatic ring, or an aromatic hetero ring, with a proviso that R⁵ and R⁶ can not simultaneously be hydrogen.

In addition, the compound that is represented by the above Formula 2 includes the compound that is represented by the following Formula 4.

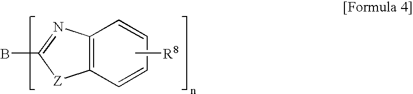

In the above Formula 4, Z is O, S, or NR^{b}, R⁸ and R^{b} are a hydrogen atom, a C₁ to C₂₄ alkyl, a C₅ to C₂₀ aromatic ring or a hetero-atom substituted aromatic ring, a halogen, or an alkylene or an alkylene containing a hetero-atom that can form a fused ring in conjunction with a benzazole ring; B is a linkage unit and alkylene, arylene, substituted alkylene, or substituted arylene that conjugately or unconjugately connects multiple benzazoles when n is 2 or more and substituted or unsubstituted alkyl or aryl when n is 1, and n is an integer in the range of 1 to 8.

Examples of the preferable compound having an imidazole group include compounds having the following structures.

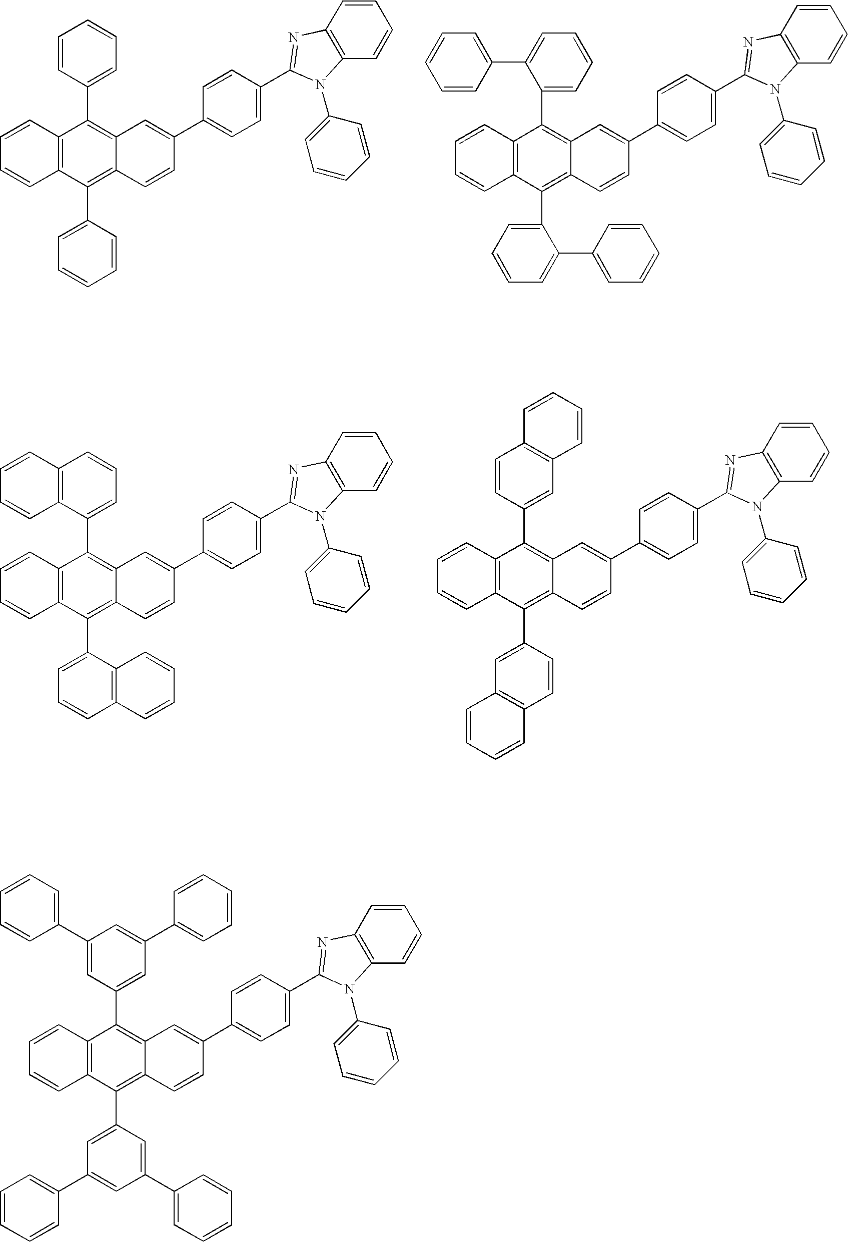

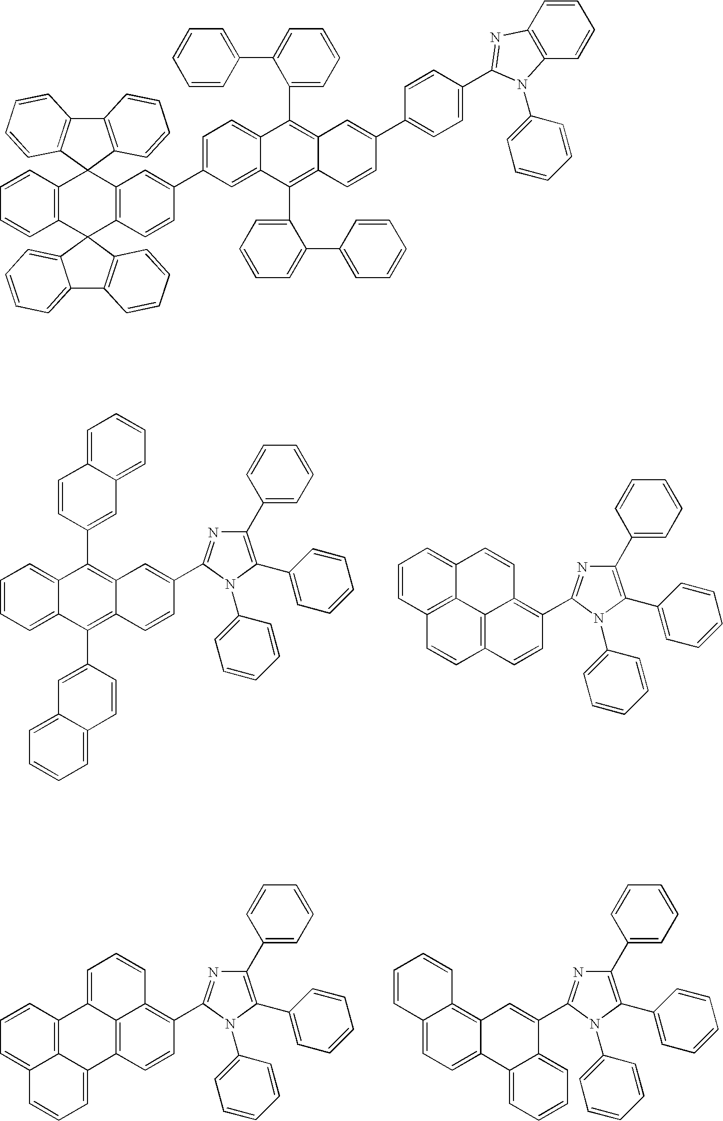

In the present invention, examples of the compound having the quinoline group include compounds that are represented by the following Formulae 5 to 11.

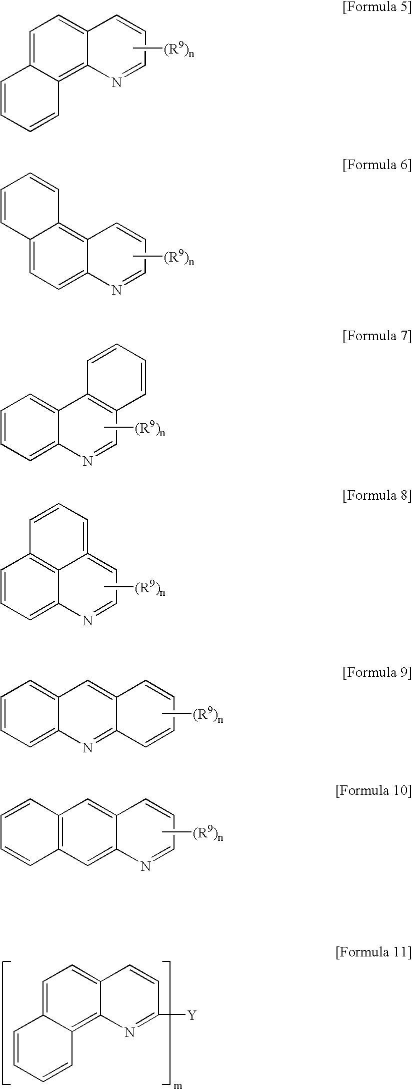

Wherein n is an integer in the range of 0 to 9, m is an integer in the range of 2 or more,

R⁹ is one selected from the group consisting of hydrogen, an alkyl group such as methyl and ethyl, a cycloalkyl group such as cyclohexyl and a norbornyl, an aralkyl group such as benzyl group, an alkenyl group such as vinyl and allyl, a cycloalkenyl group such as cyclopentadienyl and cyclohexenyl, an alkoxy group such as methoxy, an alkylthio group in which an oxygen atom in ether bonding of an alkoxy group is substituted by a sulfur atom, an arylether group such as phenoxy, an arylthioether group in which an oxygen atom in ether bonding of an arylether group is substituted by a sulfur atom, an aryl group such as phenyl, naphthyl and biphenyl, a heterocyclic group such as furyl, thienyl, oxazolyl, pyridyl, quinolyl, carbazolyl, halogen, a cyano group, an aldehyde group, a carbonyl group, a carboxyl group, an ester group, a carbamoyl group, an amino group, a nitro group, a silyl group such as trimethylsilyl, a siloxanyl group having silicon by ether bonding, and a ring structure that is formed in conjunction with an adjacent group; the above substituent groups may be unsubstituted or substituted, and the above substitutent groups are the same or different from each other when n is 2 or more, and

Y is a group having 2 or more valence of the above-mentioned R⁹ groups.

The compounds of Formulae 5 to 11 are disclosed in Korean Patent Application Publication No. 2007-0118711, the disclosures of which are incorporated herein by reference in its entirety.

In the present invention, examples of the compound having a phenanthroline group include compounds that are represented by the following Formulae 12 to 22.

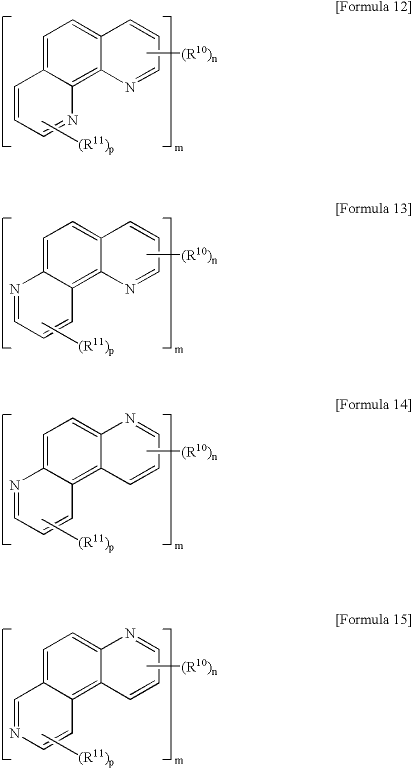

wherein m is an integer of 1 or more, n and p are integers, n+p is 8 or less,

when m is 1, R¹⁰ and R¹¹ are each one selected from the group consisting of hydrogen, an alkyl group such as methyl and ethyl, a cycloalkyl group such as cyclohexyl and a norbornyl, an aralkyl group such as benzyl group, an alkenyl group such as vinyl and allyl, a cycloalkenyl group such as cyclopentadienyl and cyclohexenyl, an alkoxy group such as methoxy, an alkylthio group in which an oxygen atom in ether bonding of an alkoxy group is substituted by a sulfur atom, an arylether group such as phenoxy, an arylthioether group in which an oxygen atom in ether bonding of an arylether group is substituted by a sulfur atom, an aryl group such as phenyl, naphthyl and biphenyl, a heterocyclic group such as furyl, thienyl, oxazolyl, pyridyl, quinolyl, carbazolyl, halogen, a cyano group, an aldehyde group, a carbonyl group, a carboxyl group, an ester group, a carbamoyl group, an amino group, a nitro group, a silyl group such as trimethylsilyl, a siloxanyl group having silicon by ether bonding, and a ring structure that is formed in conjunction with an adjacent group;

when m is 2 or more, R¹⁰ is a direct bond or a group having 2 or more valence of the above-mentioned groups, and R¹¹ is the same as the above-mentioned groups;

the above substituent groups may be unsubstituted or substituted, and the above substitutent groups are the same or different from each other when n or p is 2 or more.

The compounds of Formulae 12 to 15 are disclosed in Korean Patent Application Publication Nos. 2007-0052764 and 2007-0118711, the disclosures of which are incorporated herein by reference in its entirety.

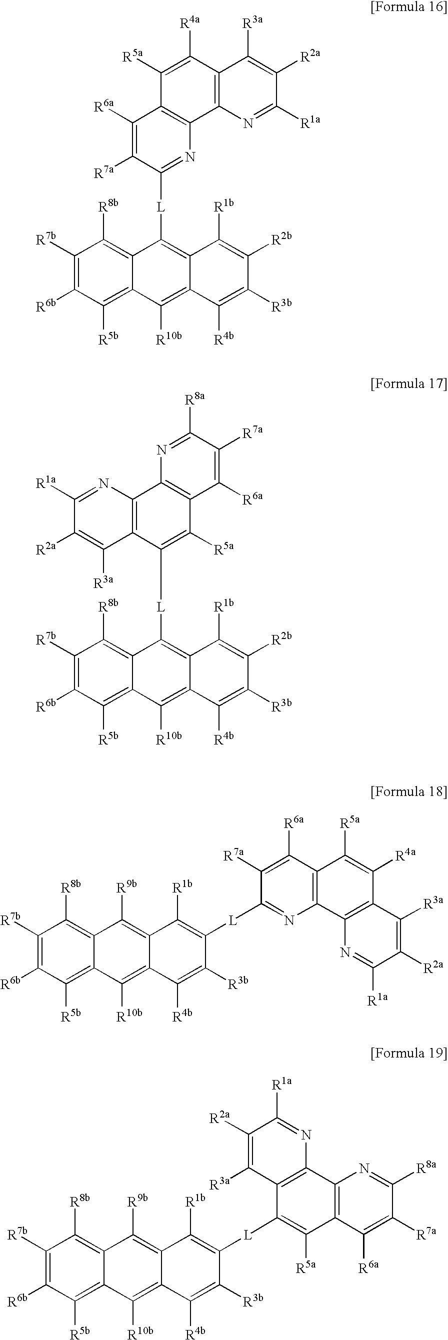

In the Formulae 16 to 19, R^{1a} to R^{8a} and R^{1b} to R^{10b} are independently selected from the group consisting of a hydrogen atom, a substituted or unsubstituted aryl group having 5-60 nuclear atoms, a substituted or unsubstituted pyridyl group, a substituted or unsubstituted quinolyl group, a substituted or unsubstituted alkyl group having 1-50 carbon atoms, a substituted or unsubstituted cycloalkyl group having 3-50 carbon atoms, a substituted or unsubstituted aralkyl group having 6˜50 nuclear atoms, a substituted or unsubstituted alkoxy group having 1-50 carbon atoms, a substituted or unsubstituted aryloxy group having 5-50 nuclear atoms, a substituted or unsubstituted arylthio group having 5-50 nuclear atoms, a substituted or unsubstituted alkoxycarbonyl group having 1-50 carbon atoms, an amino group substituted by a substituted or unsubstituted aryl group having 5-50 nuclear atoms, a halogen atom, a cyano group, a nitro group, a hydroxyl group and a carboxyl group, wherein the substituents are bonded each other to form an aromatic group; and L is a substituted or unsubstituted arylene group having 6-60 carbon atoms, a substituted or unsubstituted pyridynylene group, a substituted or unsubstituted quinolinylene group, or a substituted or unsubstituted fluorenylene group. The compounds of Formulae 16-19 are disclosed in Japanese Patent Application Publication No. 2007-39405, the disclosures of which are incorporated herein by reference in its entirety.

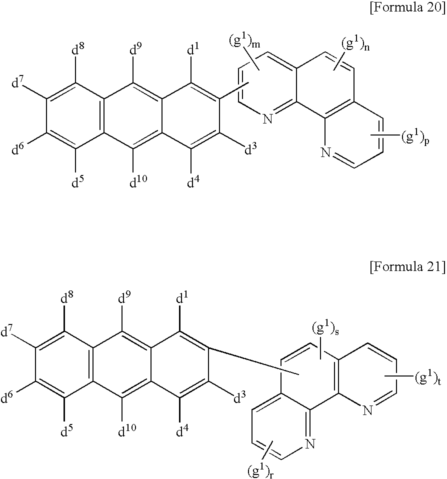

In the Formulae 20 and 21, d¹, d³ to d¹⁰ and g¹ are independently selected from the group consisting of a hydrogen atom and an aromatic or aliphatic hydrocarbon group, m and n are integers of 0 to 2, p is an integer of 0 to 3. The compounds of Formulae 20 and 21 are disclosed in U.S. Patent Application Publication No. 2007/0122656, the disclosures of which are incorporated herein by reference in its entirety.

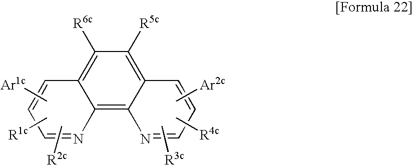

In the Formula 22, R^{1c} to R^{6c} are independently selected from the group consisting of a hydrogen atom, a substituted or unsubstituted alkyl group, a substituted or unsubstituted aralkyl group, a substituted or unsubstituted aryl group, a substituted or unsubstituted heterocyclic group and a halogen atom, and Ar^{1c} and Ar^{2c} are independently selected from the following formulae:

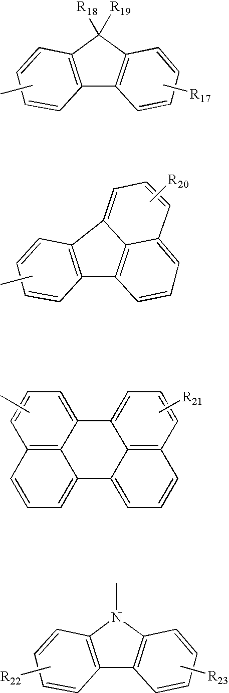

wherein R₁₇ to R₂₃ are independently selected from the group consisting of a hydrogen atom, a substituted or unsubstituted alkyl group, a substituted or unsubstituted aralkyl group, a substituted or unsubstituted aryl group, a substituted or unsubstituted heterocyclic group and a halogen atom. The compound of Formula 22 is disclosed in Japanese Patent Application Publication No. 2004-107263, the disclosures of which are incorporated herein by reference in its entirety.

In the present invention, when the organic material layer is formed by using the above-mentioned electron transporting material, at least one that is selected from the group consisting of metal halides, metal oxides and organic metal is doped as a doping material.

Examples of the above metal halides include LiF, MgF₂, NaF, KF, or the like. Examples of the above metal oxides include MgO, CaO, or the like. In the present invention, among the doping materials, it is more preferable to use metal halides, and it is even more preferable to use LiF.

In the present invention, it is preferable that at least one selected from the group consisting of metal halides, metal oxides and organic metal be included in an amount in the range of 1 to 50% by weight based on the total weight of the materials of the organic material layer including the doping material.

The organic material layer that includes the electron transporting material and the doping material may be formed by using a method that is known in the art. For example, a deposition method and a solvent process, for example, spin coating, dip coating, doctor blading, screen printing, inkjet printing, or thermal transfer method, may be used.

The organic light emitting device according to the present invention may be produced by using a typical production method and material and may have a structure known in the art, except that at least one organic material layer is formed by using the electron transporting material and the doping material.

For example, the process of producing the organic light emitting device according to the present invention includes depositing metal, metal oxides having conductivity, or an alloy thereof on a substrate by using a PVD (physical vapor deposition) method such as sputtering or e-beam evaporation to form an anode, forming an organic material layer thereon, and forming a cathode thereon. In addition to the above-mentioned method, another method may be used. For example, the cathode, the organic material layer, and the anode may be sequentially deposited on the substrate to produce the organic light emitting device.

The organic material layer may have a multilayered structure that includes the hole injecting layer, the hole transporting layer, the light emitting layer, the electron transporting layer, the electron injecting layer and the like. However, the structure of the organic material layer is not limited thereto, and a portion of the layers may be removed or additional layer may be provided. In the present invention, unlike the known technology, the electron injecting layer may not be formed to simplify the production process of the organic light emitting device and to produce the organic light emitting device having the excellent performance. Accordingly, the organic light emitting device according to the present invention may not include the electron injecting layer. That is, the organic material layer, including the electron transporting material and the doping material, may be in contact with any one electrode. However, the case of when the electron injecting layer is included is not excluded from the scope of the present invention. Therefore, an electron injecting layer can be positioned between any one electrode and the organic material layer including the electron transporting material and the doping material.

The organic material layer may be produced by means of various types of polymer materials by using a deposition method as well as a solvent process such as spin coating, dip coating, doctor blading, screen printing, inkjet printing, heat transfer method or the like so that the organic material layer has a small number of layers.

It is preferable that the anode material have a large work function so that a hole is desirably injected into the organic material layer. Specific examples of the anode material that is capable of being used in the present invention include, but are not limited to metal such as vanadium, chrome, copper, zinc, gold, nickel, and platinum, or an alloy thereof; metal oxides such as zinc oxides, indium oxides, indium tin oxides (ITO), and indium zinc oxides (IZO); metal/oxide composites such as ZnO:Al or SnO₂:Sb; and conductive polymers such as poly(3-methylthiophene), poly[3,4-(ethylene-1,2-dioxy)thiophene] (PEDT), polypyrrole, and polyaniline. In addition, in the case of when hexanitrile hexaazatriperylene that is represented by the following Formula is used as the material of the hole injecting layer, aluminum (Al), silver (Ag), calcium (Ca) or the like may be used.

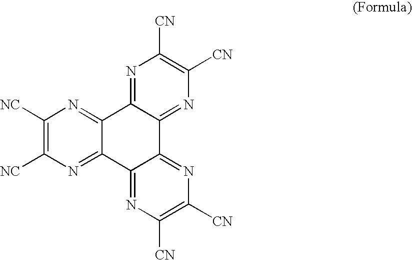

It is preferable that the cathode material have a small work function so that an electron is desirably injected into the organic material layer. Specific examples of the cathode material include, but are not limited to metal such as magnesium, calcium, sodium, potassium, titanium, indium, yttrium, lithium, gadolinium, aluminum, silver, tin, and lead, or an alloy thereof; and a multilayered material such as LiF/Al or LiO₂/Al.

The hole injecting material is a material that is capable of desirably receiving a hole from an anode at low voltage. It is preferable that the HOMO (highest occupied molecular orbital) level of the hole injecting material be located between the work function of the anode material and the HOMO level of its neighboring organic material layer. Specific examples of the hole injecting material include, but are not limited to organic materials of metal porphyrin, oligothiophene, and arylamine series, organic materials of hexanitrile hexaazatriphenylene and quinacridone series, organic materials of perylene series, and conductive polymers of on anthraquinone, polyaniline, and polythiophene series.

The hole transporting material is suitably a material having high hole mobility, which is capable of transferring holes from the anode or the hole injecting layer toward the light emitting layer. Specific examples of the hole transporting material include, but are not limited to organic materials of arylamine series, conductive polymers, and block copolymers having both conjugated portions and non-conjugated portions.

The light emitting material is a material capable of emitting visible light by accepting and recombining holes from the hole transporting layer and electrons from the electron transporting layer, and preferably a material having high quantum efficiency for fluorescence and phosphorescence. Specific examples of the light emitting material include, but are not limited to 8-hydroxyquinoline aluminum complex (Alq₃); compounds of carbazole series; dimerized styryl compounds; BAlq; 10-hydroxybenzoquinoline-metal compounds; compounds of benzoxazole, benzthiazole, and benzimidazole series; polymers of poly(p-phenylenevinylene) (PPV) series; spiro compounds; and compounds of polyfluorene and rubrene series.

In addition, the organic material layer may comprise an n-type organic material layer in contact with one electrode of the first electrode and the second electrode and a p-type organic material layer forming an NP junction together with the n-type organic material layer wherein energy levels of the layers satisfy the following Expressions (1) and (2):

E_{nL}−E_{F1}≦4 eV (1)

E_{pH}−E_{nL}≦1 eV (2)

where E_{F1} is a Fermi energy level of the electrode, E_{nL} is an LUMO energy level of the n-type organic material layer, and E_{pH} is an HOMO energy level of the p-type organic material layer forming the NP junction together with the n-type organic material layer.

When the energy difference between the LUMO energy level of the n-type organic material layer and the Fermi energy level of the electrode is more than 4 eV, an effect of a surface dipole or a gap state on an energy barrier for hole injection or hole extraction is reduced. Also, when the energy difference between the LUMO energy level of the n-type organic material layer and the HOMO energy level of the p-type organic material layer is more than approximately 1 eV, the NP junction of the p-type organic material layer and the n-type organic material layer is not easily formed and thus a driving voltage for hole injection or hole extraction increases.

The compound represented by the following Formula 23 can be used as a material for the n-type organic material layer.

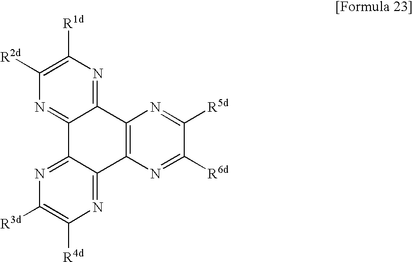

In Formula 23, each of R^{1d} to R^{6d} is selected from a group consisting of hydrogen, halogen atoms, nitrile (—CN), nitro (—NO₂), sulfonyl (—SO₂R), sulfoxide (—SOR), sulfonamide (—SO₂NR), sulfonate (—SO₃R), trifluoromethyl (—CF₃), ester (—COOR), amide (—CONHR or —CONRR′), substituted or unsubstituted straight or branched chain C₁-C₁₂ alkoxy, substituted or unsubstituted straight or branched C₁-C₁₂ alkyl, substituted or unsubstituted aromatic or non-aromatic heterocyclic rings, substituted or unsubstituted aryl, substituted or unsubstituted mono- or di-arylamine, and substituted or unsubstituted aralkylamine, and each of R and R′ are selected from a group consisting of substituted or unsubstituted C₁-C₆₀ alkyl, substituted or unsubstituted aryl, and substituted or unsubstituted 5-7 membered heterocyclic rings.

Examples of the compound of Formula 23 may include compounds represented by the following Formulae 23-1 to 23-6.

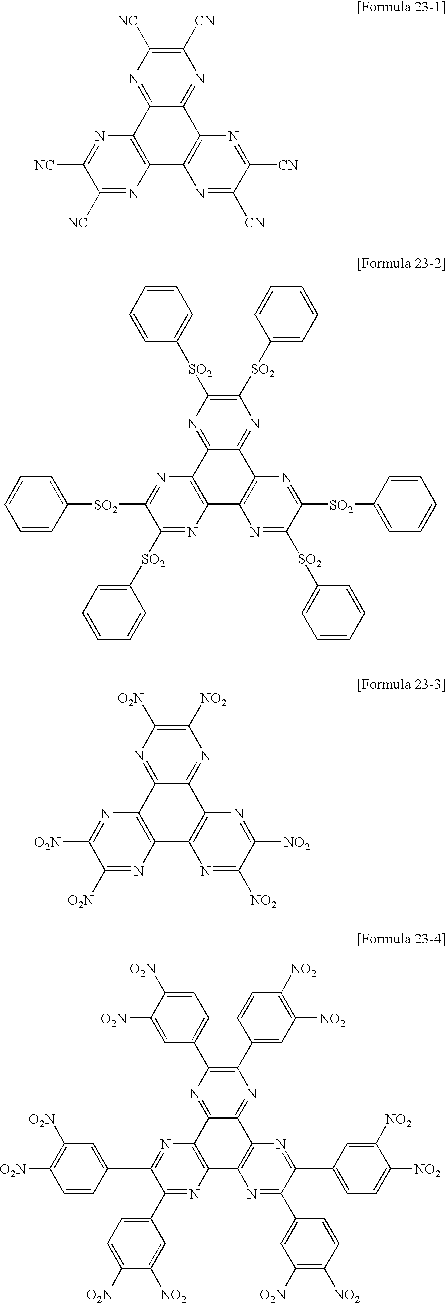

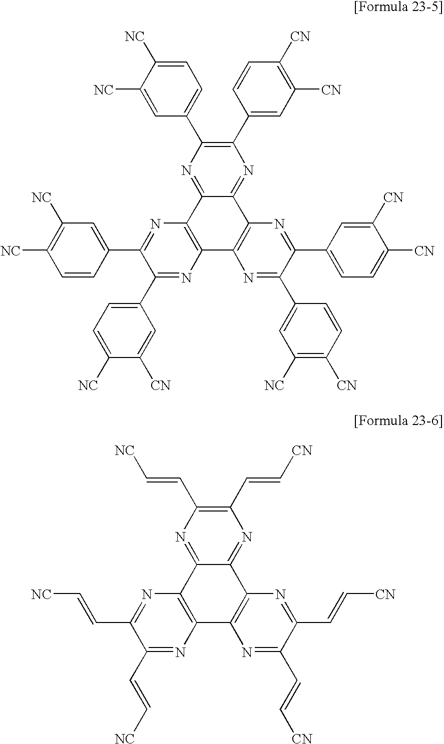

The n-type organic material layer may contain at least one compound selected from 2,3,5,6-tetrafluoro-7,7,8,8-tetracyanoquinodimethane (F4TCNQ), fluoro-substituted 3,4,9,10-perylenetetracarboxylic dianhydride (PTCDA), cyano-substituted 3,4,9,10-perylenetetracarboxylic dianhydride (PTCDA), naphthalene-tetracarboxylic-dianhydride (NTCDA), fluoro-substituted naphthalene-tetracarboxylic-dianhydride (NTCDA), or cyano-substituted naphthalene-tetracarboxylic-dianhydride (NTCDA).

The p-type organic material layer, forming an NP junction together with the n-type organic material layer, may be a hole injection layer, a hole transport layer, or emitting layer.

The organic light emitting device according to the present invention may be a top light emitting type, a bottom light emitting type, or a dual-sided light emitting type according to the type of material used. In addition, the organic light emitting device according to the present invention may have a negative structure in which the lower electrode is the cathode and the upper electrode is the anode or a positive structure in which the lower electrode is the anode and the upper electrode is the cathode.

### MODE FOR INVENTION

### Example

### Example 1

LiF was doped on the electron transporting material of the following Formula in an amount of 20% on the Al thin film having the thickness of 700 Å to form the layer having the thickness of 200 Å. Subsequently, Alq₃ (aluminum tris(8-hydroxyquinoline)) of the following Formula was deposited under a vacuum to form the light emitting layer having the thickness of 300 Å, and NPB of the following Formula was deposited thereon under a vacuum to form the hole transporting layer having the thickness of 400 Å. Subsequently, the HAT material of the following Formula was deposited thereon by heating under a vacuum to form the hole injecting layer having the thickness of 500 Å. The IZO layer was formed thereon to have a thickness of 1750 Å.

[Electron Transporting Material]

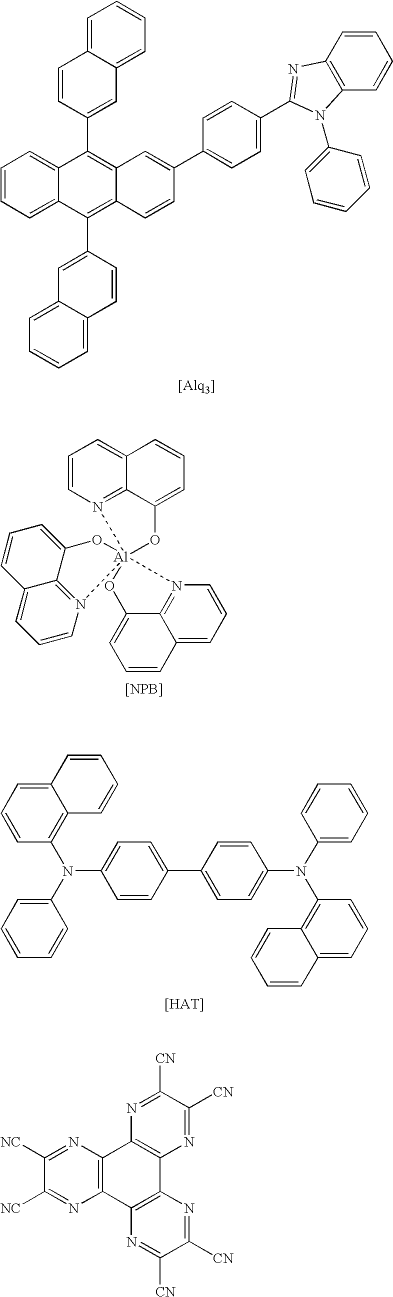

In this connection, the deposition rate of the organic material was maintained at 0.4 to 1.0 Å/sec, and the degree of vacuum was maintained at 2×10⁻⁷ to 2×10⁻⁸ torr during the deposition.

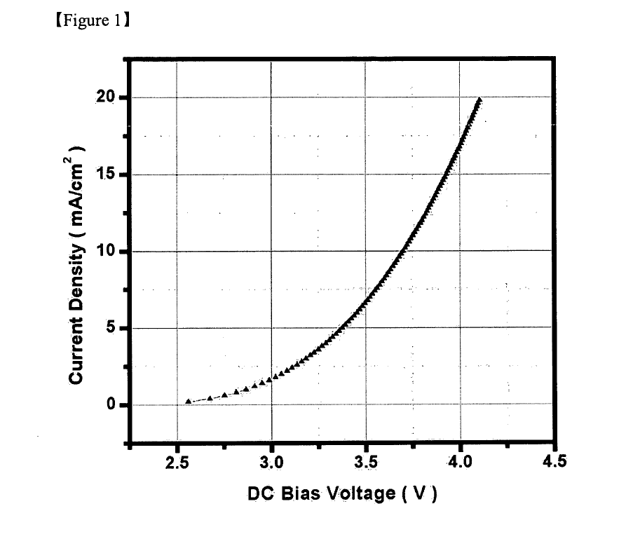

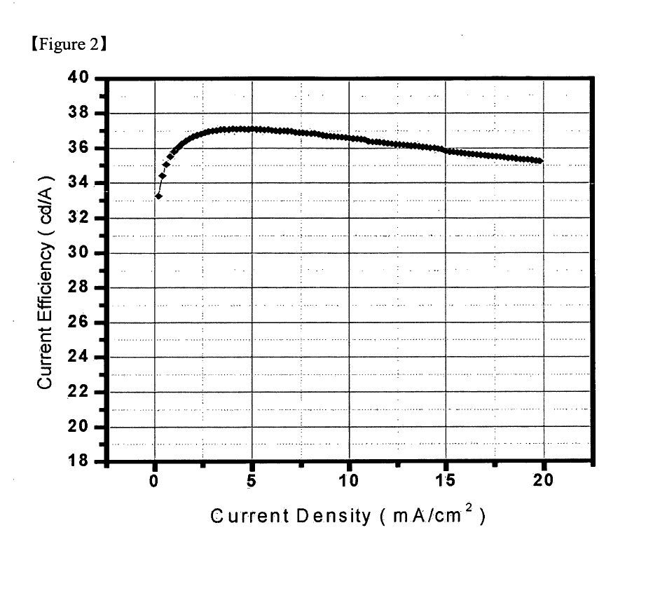

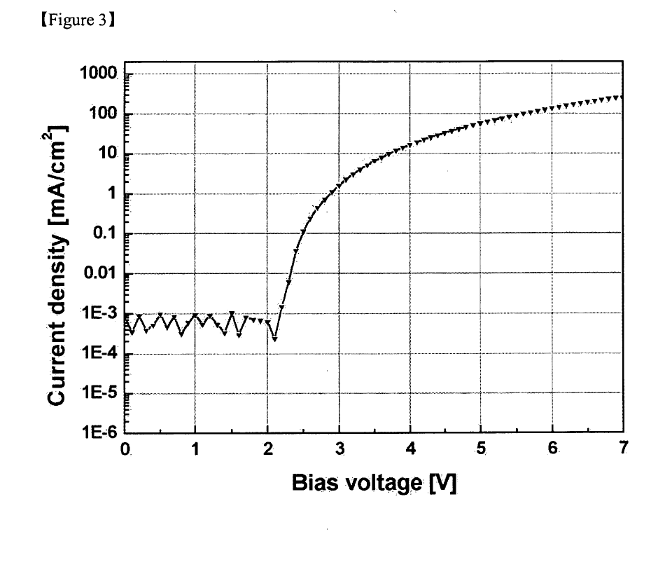

Voltage was applied on the organic light emitting device that was produced in Example 1 at the interval of 0.2 mA/cm² to measure the voltage, the luminance, and the leakage current. The results are shown in FIGS. 1, 2, and 3. FIGS. 1, 2, and 3 are graphs that illustrate the current-voltage characteristic and the light emission characteristic of the organic light emitting device. In the above-mentioned graphs, when LiF was doped on the electron transporting material in an amount of 20%, if the electrons were not injected and transported, the normal rectifying property and light emission property were not obtained, but the voltage was high and the light emission property was reduced. However, as shown in FIGS. 1 and 2, the voltage was 3.6 V at 5 mA/cm², the luminance was 37.5 cd/A, and the leakage current characteristic shown in FIG. 3 was stable. Thus, the intrinsic device characteristics of the organic light emitting device were obtained.

### Example 2

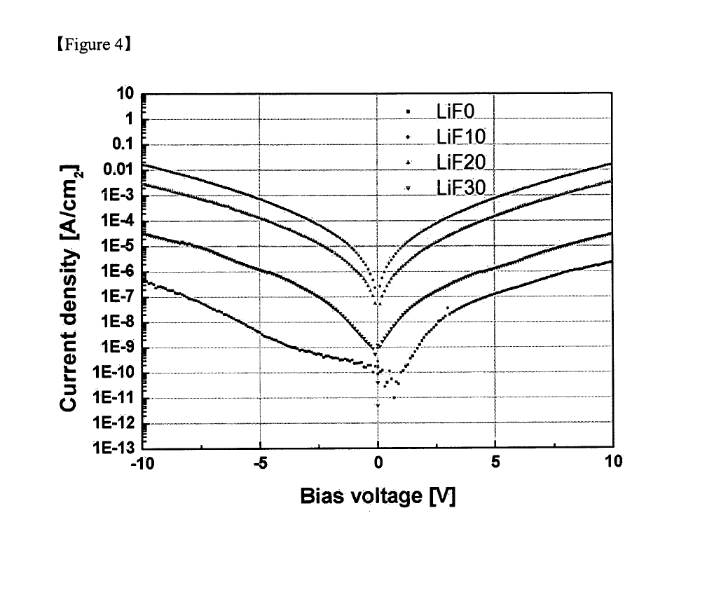

LiF was doped on the electron transporting material of Example 1 in an amount of 0%, 10%, 20%, and 30% on the Al thin film having the thickness of 700 Å to form the layer having the thickness of 1500 Å. Subsequently, Al having the thickness of 700 Å was deposited thereon. In respects to the four produced organic light emitting devices, the current density was measured according to bias voltage, and the results are shown in FIG. 4.

FIG. 4 illustrates reverse direction and forward direction current-voltage characteristics of the organic light emitting devices produced in Example 2. In the case of when LiF was doped on the electron transporting material in an amount of 0%, it was difficult to inject the electrons. In the case of when LiF was doped on the electron transporting material in an amount of 10%, 20%, and 30%, the electron injection characteristic was significantly increased.

1. An organic light emitting device comprising:
a first electrode;
a second electrode; and
at least one organic material layer that includes a light emitting layer disposed between the electrodes,
wherein at least one layer of the organic material layer includes an electron transporting material and at least one selected from the group consisting of metal halides, metal oxides and organic metal, and the electron transporting material is the compound having the functional group selected from the group consisting of an imidazole group, an oxazole group, a thiazole group, a quinoline group and a phenanthroline group.

2. The organic light emitting device according to claim 1, wherein the organic material layer further includes a hole injecting layer, a hole transporting layer, or a hole injecting and transporting layer.

3. The organic light emitting device according to claim 1, wherein the organic material layer, including an electron transporting material and at least one selected from the group consisting of metal halides, metal oxides and organic metal, is in contact with any one of the first electrode and the second electrode.

4. The organic light emitting device according to claim 1, wherein the compound having the functional group that is selected from the group consisting of the imidazole group, the oxazole group, and the thiazole group is a compound of the following Formula 1 or 2: 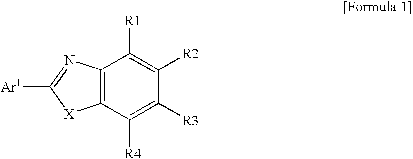
wherein R¹ to R⁴ may be the same or different from each other, are each independently a hydrogen atom; a C₁ to C₃₀ alkyl group that is unsubstituted or substituted with one or more groups selected from the group consisting of a halogen atom, an amino group, a nitrile group, a nitro group, a C₁ to C₃₀ alkyl group, a C₂ to C₃₀ alkenyl group, a C₁ to C₃₀ alkoxy group, a C₃ to C₃₀ cycloalkyl group, a C₃ to C₃₀ heterocycloalkyl group, a C₅ to C₃₀ aryl group, and a C₂ to C₃₀ heteroaryl group; a C₃ to C₃₀ cycloalkyl group that is unsubstituted or substituted with one or more groups selected from the group consisting of a halogen atom, an amino group, a nitrile group, a nitro group, a C₁ to C₃₀ alkyl group, a C₂ to C₃₀ alkenyl group, a C₁ to C₃₀ alkoxy group, a C₃ to C₃₀ cycloalkyl group, a C₃ to C₃₀ heterocycloalkyl group, a C₅ to C₃₀ aryl group, and a C₂ to C₃₀ heteroaryl group; a C₅ to C₃₀ aryl group that is unsubstituted or substituted with one or more groups selected from the group consisting of a halogen atom, an amino group, a nitrile group, a nitro group, a C₁ to C₃₀ alkyl group, a C₂ to C₃₀ alkenyl group, a C₁ to C₃₀ alkoxy group, a C₃ to C₃₀ cycloalkyl group, a C₃ to C₃₀ heterocycloalkyl group, a C₅ to C₃₀ aryl group, and a C₂ to C₃₀ heteroaryl group; or a C₂ to C₃₀ heteroaryl group that is unsubstituted or substituted with one or more groups selected from the group consisting of a halogen atom, an amino group, a nitrile group, a nitro group, a C₁ to C₃₀ alkyl group, a C₂ to C₃₀ alkenyl group, a C₁ to C₃₀ alkoxy group, a C₃ to C₃₀ cycloalkyl group, a C₃ to C₃₀ heterocycloalkyl group, a C₅ to C₃₀ aryl group, and a C₂ to C₃₀ heteroaryl group, and may form an aliphatic, aromatic, aliphatic hetero, or aromatic hetero condensation ring or a spiro bond in conjunction with a neighboring group; Ar¹ is a hydrogen atom, a substituted or unsubstituted aromatic ring or a substituted or unsubstituted aromatic hetero ring; X is O, S, or NR^{a}, and R^{a} is hydrogen, a C₁ to C₇ aliphatic hydrocarbon, an aromatic ring or an aromatic hetero ring, 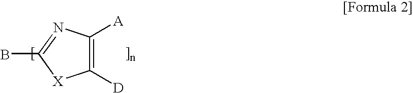
wherein X is O, S, NR^{b} or a C₁ to C₇ divalent hydrocarbon group; A, D, and R^{b} are each a hydrogen atom, a nitrile group (—CN), a nitro group (—NO₂), a C₁ to C₂₄ alkyl, a C₅ to C₂₀ aromatic ring or a hetero-atom substituted aromatic ring, a halogen, or an alkylene or an alkylene having a hetero-atom that can form a fused ring in conjunction with an adjacent ring; A and D may be connected to each other to form an aromatic or hetero aromatic ring; B is a linkage unit and substituted or unsubstituted alkylene or arylene that conjugately or unconjugately connects multiple hetero rings when n is 2 or more, and substituted or unsubstituted alkyl or aryl when n is 1; and n is an integer in the range of 1 to 8.

5. The organic light emitting device according to claim 4, wherein the Formula 1 is represented by the following Formula 3: 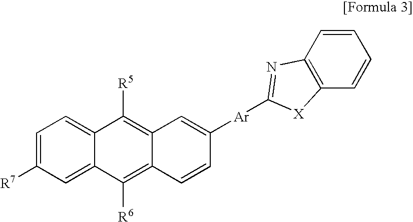
wherein R⁵ to R⁷ are the same or different from each other, are each independently a hydrogen atom, a C₁ to C₂₀ aliphatic hydrocarbon, an aromatic ring, an aromatic hetero ring or an aliphatic or aromatic fused ring; Ar is a direct bond, an aromatic ring or an aromatic hetero ring; and X is O, S, or NR^{a}, R^{a} is a hydrogen atom, a C₁ to C₇ aliphatic hydrocarbon, an aromatic ring, or an aromatic hetero ring, with a proviso that R⁵ and R⁶ can not simultaneously be hydrogen.

6. The organic light emitting device according to claim 4, wherein the compound having the functional group that is selected from the group consisting of the imidazole group, the oxazole group, and the thiazole group is selected from compounds of the following Formulae:

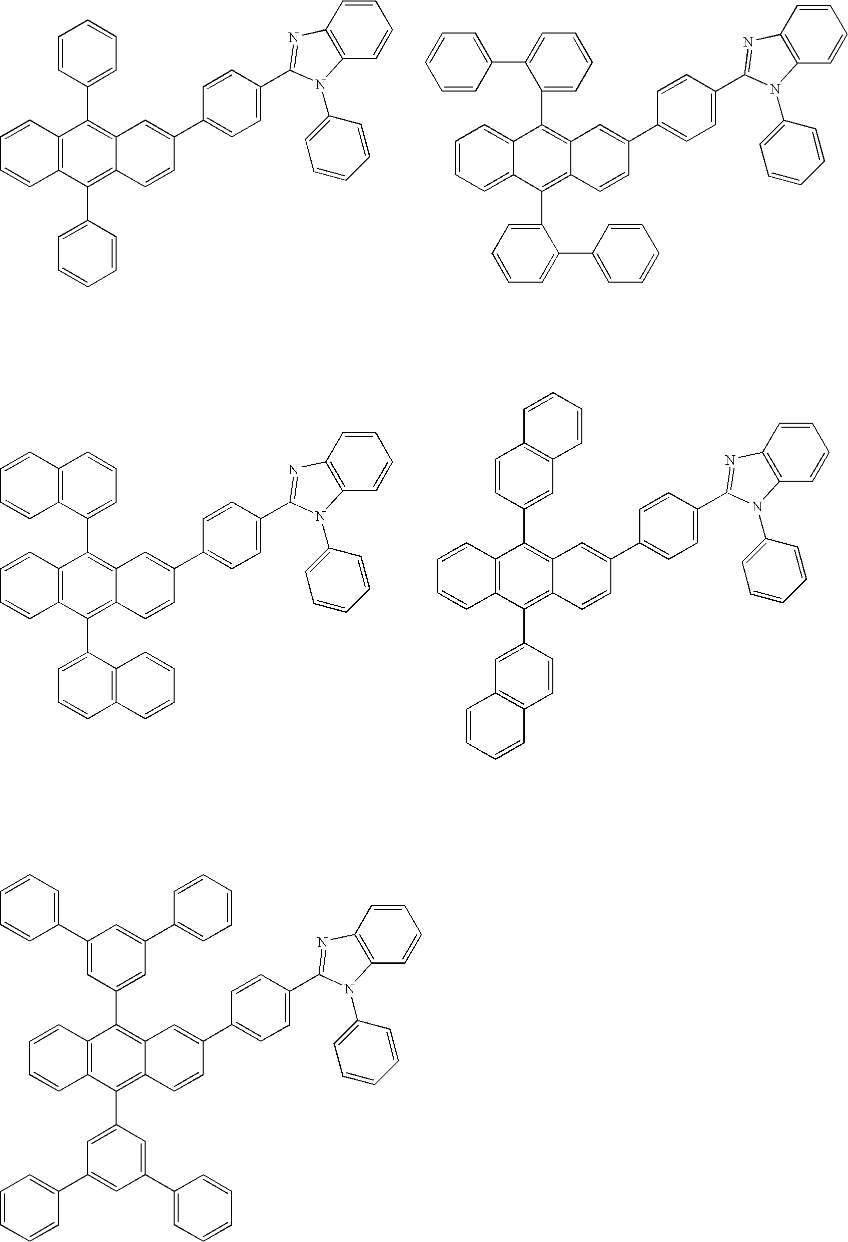

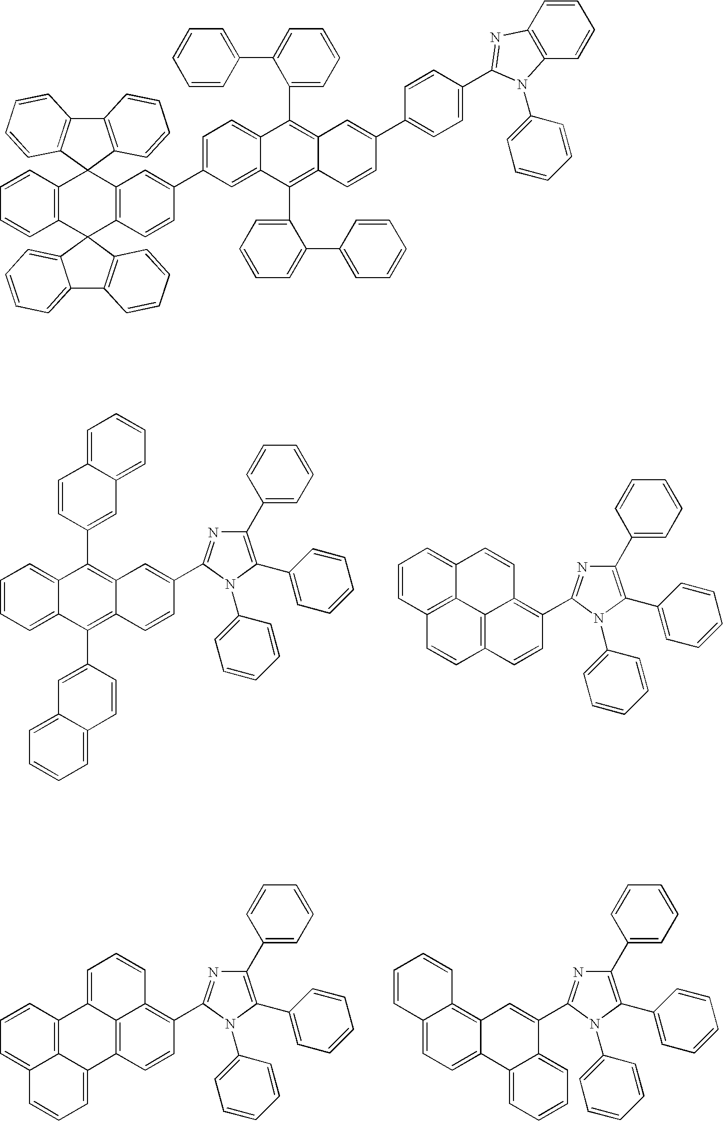

7. The organic light emitting device according to claim 1, wherein the compound having the quinoline group is selected from compounds of the following Formulae 5 to 11: 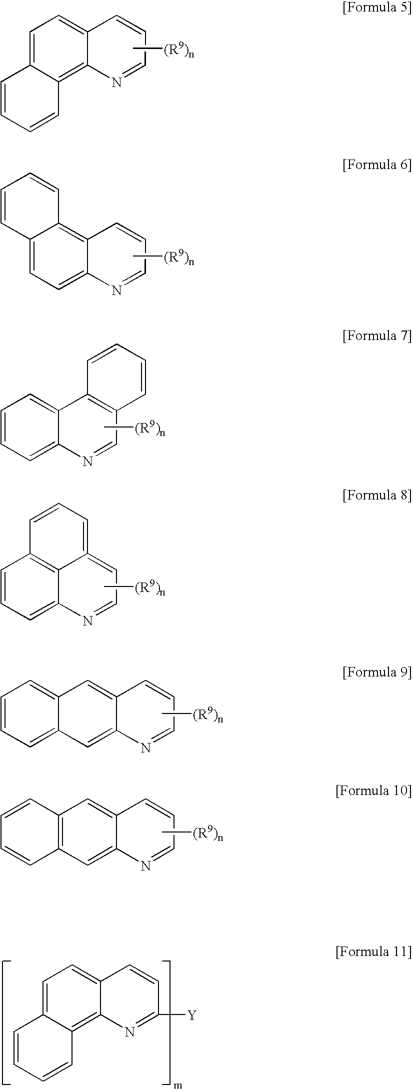
wherein n is an integer in the range of 0 to 9, m is an integer in the range of 2 or more,
R⁹ is one selected from the group consisting of hydrogen, an alkyl group, a cycloalkyl group, an aralkyl group, an alkenyl group, a cycloalkenyl group, an alkoxy group, an alkylthio group, an arylether group, an arylthioether group, an aryl group, a heterocyclic group, halogen, a cyano group, an aldehyde group, a carbonyl group, a carboxyl group, an ester group, a carbamoyl group, an amino group, a nitro group, a silyl group, a siloxanyl group, and a ring structure that is formed in conjunction with an adjacent group; the above substituent groups may be unsubstituted or substituted, and the above substitutent groups are the same or different from each other when n is 2 or more, and
Y is a group having 2 or more valence of the above-mentioned R⁹ groups.

8. The organic light emitting device according to claim 1, wherein the compound having the phenanthroline group is selected from the group consisting of compounds of the following Formulae 12 to 22: 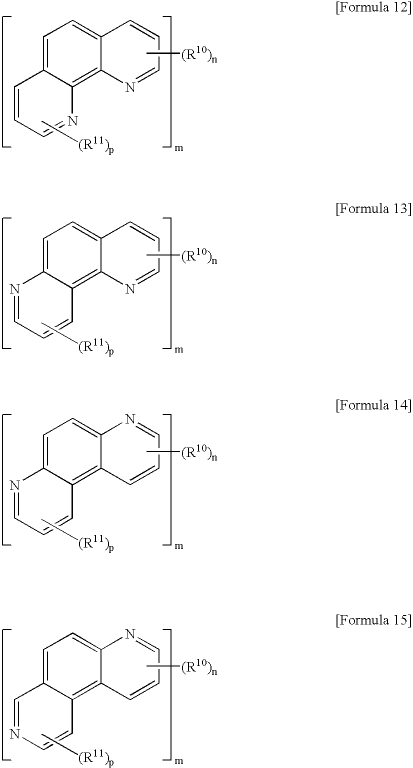
wherein m is an integer of 1 or more, n and p are integers, n+p is 8 or less,
when m is 1, R¹⁰ and R¹¹ are each one selected from the group consisting of hydrogen, an alkyl group, a cycloalkyl group, an aralkyl group, an alkenyl group, a cycloalkenyl group, an alkoxy group, an alkylthio group, an arylether group, an arylthioether group, an aryl group, a heterocyclic group, halogen, a cyano group, an aldehyde group, a carbonyl group, a carboxyl group, an ester group, a carbamoyl group, an amino group, a nitro group, a silyl group, a siloxanyl group, and a ring structure that is formed in conjunction with an adjacent group;
when m is 2 or more, R¹⁰ is a direct bond or a group having 2 or more valence of the above-mentioned groups, and R¹¹ is the same as the above-mentioned groups;
the above substituent groups may be unsubstituted or substituted, and the above substitutent groups are the same or different from each other when n or p is 2 or more, 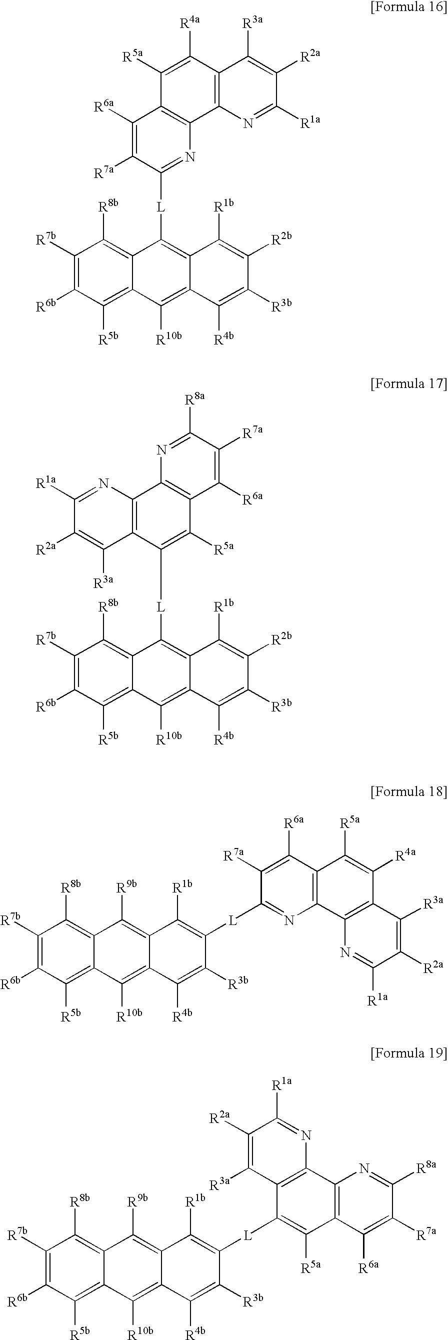
wherein R^{1a} to R^{8a} and R^{1b} to R^{10b} are independently selected from the group consisting of a hydrogen atom, a substituted or unsubstituted aryl group having 5-60 nuclear atoms, a substituted or unsubstituted pyridyl group, a substituted or unsubstituted quinolyl group, a substituted or unsubstituted alkyl group having 1-50 carbon atoms, a substituted or unsubstituted cycloalkyl group having 3-50 carbon atoms, a substituted or unsubstituted aralkyl group having 6˜50 nuclear atoms, a substituted or unsubstituted alkoxy group having 1-50 carbon atoms, a substituted or unsubstituted aryloxy group having 5-50 nuclear atoms, a substituted or unsubstituted arylthio group having 5-50 nuclear atoms, a substituted or unsubstituted alkoxycarbonyl group having 1-50 carbon atoms, an amino group substituted by a substituted or unsubstituted aryl group having 5-50 nuclear atoms, a halogen atom, a cyano group, a nitro group, a hydroxyl group and a carboxyl group, wherein the substituents are bonded each other to form an aromatic group; and L is a substituted or unsubstituted arylene group having 6-60 carbon atoms, a substituted or unsubstituted pyridynylene group, a substituted or unsubstituted quinolinylene group, or a substituted or unsubstituted fluoreneylene group, 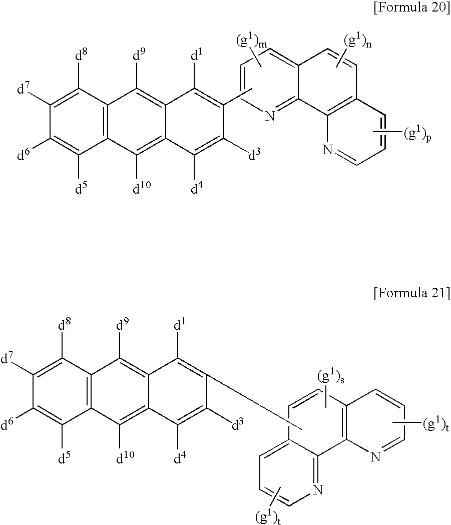
wherein d¹, d³ to d¹⁰ and g¹ are independently selected from the group consisting of a hydrogen atom and an aromatic or aliphatic hydrocarbon group, m and n are integers of 0 to 2, p is an integer of 0 to 3, 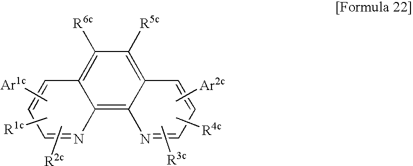
wherein R^{1c} to R^{6c} are independently selected from the group consisting of a hydrogen atom, a substituted or unsubstituted alkyl group, a substituted or unsubstituted aralkyl group, a substituted or unsubstituted aryl group, a substituted or unsubstituted heterocyclic group and a halogen atom, and Ar^{1c} and Ar^{2c} are independently selected from the following formulae: 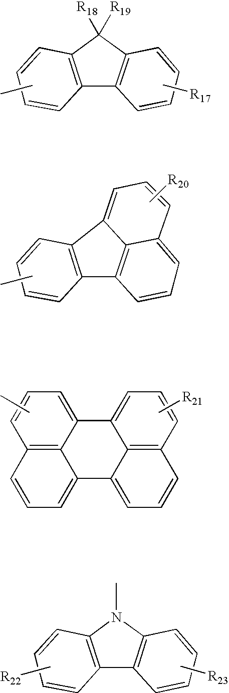
wherein R₁₇ to R₂₃ are independently selected from the group consisting of a hydrogen atom, a substituted or unsubstituted alkyl group, a substituted or unsubstituted aralkyl group, a substituted or unsubstituted aryl group, a substituted or unsubstituted heterocyclic group and a halogen atom.

9. The organic light emitting device according to claim 1, wherein the metal halides are selected from LiF, MgF₂, NaF, and KF.

10. The organic light emitting device according to claim 1, wherein the metal oxides are selected from MgO and CaO.

11. The organic light emitting device according to claim 1, wherein the electron transporting material is a compound of the following Formula, and at least one selected from the group consisting of metal halides, metal oxides and organic metal is LiF:

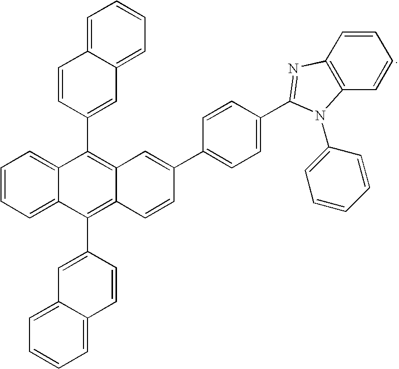

12. The organic light emitting device according to claim 1, wherein at least one selected from the group consisting of metal halides, metal oxides and organic metal is included in an amount in the range of 1 to 50% by weight based on a total weight of a material of the organic material layer including metal halides, metal oxides, inorganic metal, or organic metal.

13. The organic light emitting device according to claim 1, wherein an electron injecting layer is positioned between any one of the first electrode and the second electrode and the organic material layer, including an electron transporting material and at least one selected from the group consisting of metal halides, metal oxides and organic metal.

14. The organic light emitting device according to claim 1, wherein the organic material layer comprises an n-type organic material layer in contact with one electrode of the first electrode and the second electrode and a p-type organic material layer that forms an NP junction together with the n-type organic material layer, and energy levels of the layers satisfy the following Expressions (1) and (2):
E_{nL}−E_{F1}≦4 eV (1)
E_{pH}−E_{nL}≦1 eV (2)
Wherein E_{F1} is a Fermi energy level of the electrode, E_{nL} is an LUMO energy level of the n-type organic material layer, and E_{pH} is an HOMO energy level of the p-type organic material layer forming the NP junction together with the n-type organic material layer.

15. A method of producing the organic light emitting device, comprising:
forming a first electrode;
forming at least one organic material layer including a light emitting layer on the first electrode; and
forming a second electrode on the organic substance layer,
wherein at least one layer of the organic material layer is formed by doping at least one selected from the group consisting of metal halides, metal oxides and organic metal on an electron transporting material that is the compound having the functional group selected from the group consisting of an imidazole group, an oxazole group, a thiazole group, a quinoline group and a phenanthroline group.
